(19) United States
(12) Patent Application Publication
(10) Pub. No.: US 2024/0260163 A1
(43) Pub. Date: Aug. 1, 2024

(54) VEHICLE STATIC ELIMINATOR AND VEHICLE EQUIPPED WITH THE SAME

(71) Applicant: TOYOTA JIDOSHA KABUSHIKI KAISHA, Aichi-ken (JP)

(72) Inventors: Yuya SEKIGAWA, Toki-shi (JP); Toshio TANAHASHI, Susono-shi (JP)

(21) Appl. No.: 18/426,341

(22) Filed: Jan. 30, 2024

(30) Foreign Application Priority Data
Feb. 1, 2023 (JP) 2023-013750

(51) Int. Cl. H05F 3/02; B60N 2/90

(52) U.S. Cl. CPC H05F 3/02; B60N 2/90

(57) ABSTRACT

A vehicle static eliminator comprises a flannel fabric that indirectly contacts a back frame mounted on a vehicle body and has zero triboelectric potential, and a PTFE sheet that is layered on the flannel fabric so as to frictionally slide with the flannel fabric and charged with negative static electricity generated by sliding friction with the flannel fabric, to thereby neutralize and eliminate positive static electricity charged on the vehicle body.

### CROSS REFERENCE TO RELATED APPLICATION

This application claims priority to Japanese Patent Application No. 2023-013750 filed on Feb. 1, 2023, which is incorporated herein by reference in its entirety including the specification, claims, drawings, and abstract.

### TECHNICAL FIELD

The present disclosure relates to a structure of a vehicle static eliminator and a structure of a vehicle equipped with the vehicle static eliminator.

### BACKGROUND

It has been known that a vehicle in an insulation state from a road surface may be charged with positive static electricity on its body due to external factors including driving on the road surface, and that this positive static electricity charged on the vehicle may affect the operation of the vehicle. As a countermeasure for such positive static electricity charged on the vehicle body, a structure has been proposed in which a positive charge member and a negative charge member are arranged in a seat so as to rub against each other according to the passenger's movement, and the negative charge member is connected to the vehicle body via a ground wire (see, for example, JP 2019-117709 A). This structure makes it possible to cause flow of negative static electricity generated in the negative charge member due to rubbing movements to the vehicle body via the ground wire, to thereby neutralize and eliminate positive static electricity charged on the vehicle body.

### CITATION LIST

PATENT DOCUMENT 1: JP 2019-117709 A

### SUMMARY

However the static eliminator described in JP 2019-117709 A requires provision of the ground wire for connecting between the negative charge member and the vehicle body, and that the skin of the seat is made of the negative charge member and the positive charge member that differ from normal seat skin materials. As a result, it is difficult to install such a static eliminator in a vehicle that is bought and owned by a user.

Accordingly, an object of the present disclosure is to eliminate static electricity from a vehicle owned by a user by using a simple configuration.

A vehicle static eliminator according to the present disclosure includes a first zero potential member that directly or indirectly contacts a metal interior member mounted on a body of a vehicle and has zero triboelectric potential, and a negative charge member that is layered on the first zero potential member so as to frictionally slide with respect to the first zero potential member and is charged with negative static electricity generated by sliding friction with the first zero potential member, to thereby neutralize and eliminate positive static electricity charged on the body.

This configuration makes it possible to cause dielectric polarization of the first zero potential member and neutralize and eliminate negative static electricity charged on the negative charge member by using positive static electricity charged on the metal interior member. Thus, it is possible to eliminate static electricity from the body of the vehicle on which the metal interior member is mounted.

In the vehicle static eliminator according to the present disclosure, the first zero potential member may be made of a natural fiber with zero electric potential in the triboelectric series, and the negative charge member may be made of a resin material.

This makes it possible to achieve a vehicle static eliminator having a simple configuration by using common materials.

The vehicle static eliminator according to the present disclosure may include a second zero potential member that is layered on the negative charge member opposite the first zero potential member, and the second zero potential member may be made of a natural fiber with zero electric potential in the triboelectric series.

This configuration makes it possible to prevent discharge of negative static electricity generated in the negative charge member to the outside from the side opposite to the metal interior member. The vehicle static eliminator can thus effectively neutralize and eliminate negative static electricity generated in the negative charge member by using positive static electricity charged on the metal interior member.

The vehicle static eliminator according to the present disclosure may include an antistatic resin member that is layered on the negative charge member opposite the first zero potential member, and the antistatic resin member may be attached to the negative charge member with an adhesive material.

This makes it possible to prevent discharge of negative static electricity generated in the negative charge member to the outside from the side opposite to the metal interior member. The vehicle static eliminator can thus effectively neutralize and eliminate negative static electricity generated in the negative charge member by using positive static electricity charged on the metal interior member.

A vehicle according to the present disclosure is a vehicle on which the vehicle static eliminator is mounted. The vehicle includes a seat including a seat frame that is the interior member, a first seat cover that covers the outside of the seat frame, and a second seat cover that covers the outside of the first seat cover. The vehicle static eliminator is sandwiched between the first seat cover and the second seat cover, and the first zero potential member is disposed so as to contact the seat frame indirectly through the first seat cover. The negative charge member is sandwiched between the first zero potential member and the second seat cover and is pressed against the first zero potential member in a frictionally slidable manner.

As such, by disposing the vehicle static eliminator between the first seat cover and the second seat cover of the seat, it is possible to eliminate static electricity from the body. It is thus possible to eliminate static electricity from the vehicle owned by the user by using such a simple configuration. In addition, the negative charge member is charged with negative static electricity when it frictionally slides with respect to the first zero potential member due to, for example, vehicle startup and running vibration, and thus it is possible to eliminate static electricity from the body simply by installing the vehicle static eliminator.

A vehicle according to the present disclosure is a vehicle on which the vehicle static eliminator is mounted. The vehicle includes a seat including a seat frame that is the interior member, a first seat cover that covers the outside of the seat frame, and a second seat cover that covers the outside of the first seat cover. The vehicle static eliminator is sandwiched between the first seat cover and the second seat cover. The first zero potential member is disposed so as to contact the seat frame indirectly through the first seat cover. The second zero potential member is disposed such that one side of the second zero potential member is layered on the negative charge member opposite the seat frame, and the other side of the second zero potential member contacts the second seat cover. The negative charge member is sandwiched between the first zero potential member and the second seat cover and is pressed against the first zero potential member in a frictionally slidable manner.

As such, by disposing the vehicle static eliminator between the first seat cover and the second seat cover of the seat, it is possible to eliminate static electricity from the body. It is thus possible to eliminate static electricity from the vehicle owned by the user by using such a simple configuration. In addition, by layering the second zero potential member on the negative charge member opposite the seat frame, it is possible to prevent discharge of negative static electricity generated in the negative charge member to the outside from the side opposite to the seat frame. The vehicle static eliminator can thus effectively neutralize and eliminate negative static electricity generated in the negative charge member by using positive static electricity charged on the seat frame. Further, the negative charge member is charged with negative static electricity when it frictionally slides due to, for example, vehicle startup and running vibration, and thus static electricity can be eliminated from the body simply by installing the vehicle static eliminator.

A vehicle according to the present disclosure is a vehicle on which the vehicle static eliminator is mounted. The vehicle includes a seat including a seat frame that is the interior member, a first seat cover that covers the outside of the seat frame, and a second seat cover that covers the outside of the first seat cover. The vehicle static eliminator is sandwiched between the first seat cover and the second seat cover, and the first zero potential member is disposed so as to contact the seat frame indirectly through the first seat cover. The antistatic resin member is disposed such that one side of the antistatic resin member is layered on the negative charge member opposite the seat frame, and the other side of the antistatic resin member contacts the second seat cover. The negative charge member is pressed against the first zero potential member in a frictionally slidable manner.

As such, by layering the antistatic resin member on the negative charge member opposite the seat frame, it is possible to prevent discharge of negative static electricity generated in the negative charge member to the outside from the side opposite to the seat frame. The vehicle static eliminator can thus effectively neutralize and eliminate negative static electricity generated in the negative charge member by using positive static electricity charged on the seat frame. Further, the negative charge member is charged with negative static electricity when it frictionally slides due to, for example, vehicle startup and running vibration, and thus static electricity can be eliminated from the body simply by installing the vehicle static eliminator.

A vehicle according to the present disclosure is a vehicle on which the vehicle static eliminator is mounted. The vehicle includes a seat having a seat frame that is the interior member. The vehicle static eliminator is mounted such that the first zero potential member directly contacts the seat frame, and the second zero potential member is layered on the negative charge member opposite the seat frame and crimped to the seat frame by means of an outer cover covering an outer surface of the second zero potential member. The negative charge member is sandwiched between the first zero potential member and the second zero potential member and is pressed against the first zero potential member in a frictionally slidable manner.

It is possible to eliminate static electricity from the body by using such a simple configuration.

In the vehicle according to the present disclosure, the seat may include a back frame that supports the back of an occupant. The first seat cover may cover a rear surface of the back frame, and the second seat cover may be placed over a rear surface of the first seat cover to thereby form a seat pocket on a rear surface of the seat.

As such, by inserting the vehicle static eliminator into the seat pocket, it is possible to easily eliminate static electricity from the body.

In the vehicle according to the present disclosure, the seat may include a back frame that supports the back of an occupant. The first seat cover may cover a rear surface of the back frame, and the second seat cover may be a rear cover that has a peripheral portion fixed to a surface of the first seat cover and presses the negative charge member and the first zero potential member against each other in a frictionally slidable manner.

It is possible to eliminate static electricity from the body by using such a simple configuration.

In the vehicle according to the present disclosure, the seat may include a recess that accommodates a retractable armrest, and a back frame that supports the back of an occupant. The first seat cover may be a bottom cover that covers a front surface of the back frame at a bottom of the recess. The second seat cover may be a front cover that has a peripheral portion fixed to a surface of the bottom cover and presses the negative charge member and the first zero potential member against each other in a frictionally slidable manner.

It is possible to eliminate static electricity from the body by using such a simple configuration.

The vehicle according to the present disclosure may include a box provided adjacent to the seat. The seat may include a back frame that supports the back of an occupant. The first seat cover may be a first side cover that covers a side surface of the back frame on one side inside the box, and the second seat cover may be a second side cover that has a peripheral portion fixed to a surface of the first side cover and presses the negative charge member and the first zero potential member against each other in a frictionally slidable manner.

It is possible to eliminate static electricity from the body by using such a simple configuration.

In the vehicle according to the present disclosure, the first zero potential member may be disposed such that its entire surface directly or indirectly contacts the seat frame.

It is thus possible to eliminate static electricity from the body in an effective manner.

In the vehicle according to the present disclosure, the seat frame may include a main frame that supports the buttocks of the occupant and a back frame that supports the back of the occupant. The seat may include a cushion attached to the main frame and a backrest attached to the back frame. An antistatic agent may be applied to a seating surface of the cushion and a backrest surface of the backrest. In addition, skin of the cushion and the backrest may be made of a synthetic resin material. The antistatic agent may contain a cationic surfactant. The skin of the cushion and the backrest may be made of a leather material, and the antistatic agent may contain a fluoropolymer agent.

It is thus possible to eliminate static electricity from the body in an effective manner.

The present disclosure makes it possible to eliminate static electricity from a vehicle owned by a user by using a simple configuration.

### BRIEF DESCRIPTION OF DRAWINGS

Embodiments of the present disclosure will be described based on the following figures, wherein:

FIG. 1 is an elevational cross-sectional view showing a configuration of a vehicle on which a vehicle static eliminator according to a first embodiment is mounted;

FIG. 2 is an explanatory view showing charged states of a vehicle body, a seat, and the vehicle static eliminator shown in FIG. 1;

FIG. 3 is an explanatory view showing changes in potential of the vehicle body, a back frame of a seat frame, and the vehicle static eliminator shown in FIG. 2;

FIG. 4 is an explanatory view showing a configuration of another vehicle on which a vehicle static eliminator according to a second embodiment is mounted, along with charged states of the body, the seat, and the vehicle static eliminator;

FIG. 5 is an explanatory view showing changes in potential of the vehicle body, the back frame of the seat frame, and the vehicle static eliminator shown in FIG. 4;

FIG. 6 is an explanatory view showing a configuration of another vehicle on which a vehicle static eliminator according to a modification of the vehicle static eliminator of the second embodiment is mounted, along with charged states of the body, the seat, and the vehicle static eliminator;

FIG. 7 is an explanatory view showing a configuration of another vehicle on which the vehicle static eliminator according to a third embodiment is mounted, along with charged states of the body, the seat, and the vehicle static eliminator;

FIG. 8 is an elevational cross-sectional view of another vehicle on which the vehicle static eliminator according to the second embodiment is mounted;

FIG. 9 is an elevational cross-sectional view showing a modification of the vehicle shown in FIG. 8;

FIG. 10 is an elevational cross-sectional view of another vehicle on which the vehicle static eliminator according to the second embodiment is mounted;

FIG. 11 is an elevational cross-sectional view of another vehicle on which the vehicle static eliminator according to the second embodiment is mounted; and

FIG. 12 is an elevational cross-sectional view showing another configuration of the vehicle on which the vehicle static eliminator according to the first embodiment is mounted.

### DESCRIPTION OF EMBODIMENTS

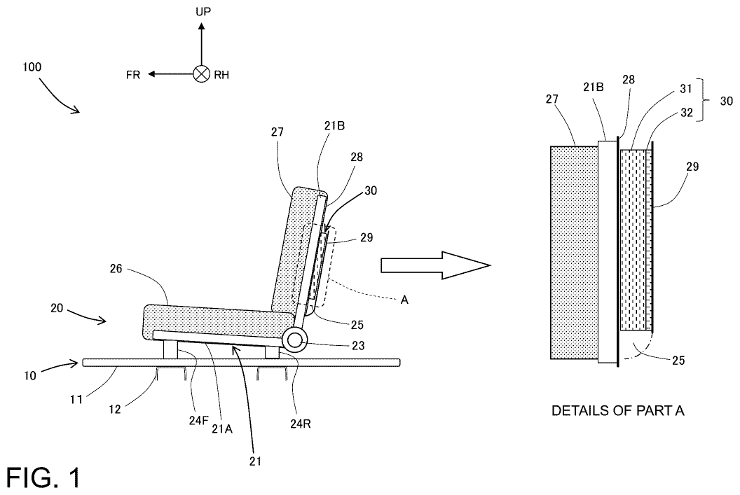

Vehicles 100, 110, 120, 130, 140, 150, and 160 and vehicle static eliminators 30, 35, 38, and 39 will be described with reference to the drawings. The vehicles 100, 110, 120, 130, 140, 150, and 160 are vehicles that are bought and owned by users. First, the vehicle static eliminator 30 that is a first embodiment and the vehicle 100 on which the vehicle static eliminator 30 is mounted will be described with reference to FIGS. 1 to 3. In the drawings, arrows “FR”, “UP”, and “RH” respectively represent the front side, the upper side, and the right side of the vehicles 100, 110, 120, 130, 140, 150, and 160. In addition, the directions opposite to the arrows “FR”, “UP”, and “RH” respectively represent the rear side, the lower side, and the left side of the vehicles 100, 110, 120, 130, 140, 150, and 160. Hereinafter, when the description is given simply using front and rear, right and left, and up and down directions, unless otherwise specified, they respectively indicate front and rear in the front-and-rear direction, right and left in the right-and-left direction, and up and down in the up-and-down direction of the vehicles 100, 110, 120, 130, 140, 150, and 160.

As shown in FIG. 1, the vehicle 100 is provided with a body 10, a seat 20, and the vehicle static eliminator 30. The body 10 includes floor cross members 12 and a floor panel 11. The floor cross members 12 are structural members that constitutes the body 10 and are channel-shaped members extending in the vehicle width direction. The floor panel 11 is mounted on the floor cross members 12 and constitutes the floor of a passenger compartment. The floor cross member 12 and the floor panel 11 are made of metal.

The seat 20 includes a seat frame 21, a cushion 26, and a backrest 27. The seat frame 21 is a strength member that supports an occupant and constitutes a metal interior member. The seat frame 21 is composed of a main frame 21A that supports the buttocks of the occupant, a back frame 21B that supports the back of the occupant, and a hinge 23. The main frame 21A, the back frame 21B, and the hinge 23 are all made of metal. The main frame 21A is mounted to the floor panel 11 with a front metal bracket 24F and a rear metal bracket 24R to support the load of the occupant. The main frame 21A has the hinge 23 at its rear end. The back frame 21B is mounted with the hinge 23 such that it can pivot about the main frame 21A. Thus, the main frame 21A, the hinge 23, and the back frame 21B are electrically connected to the body 10.

The cushion 26 is mounted on a top of the main frame 21A and supports the buttocks of the occupant. The cushion 26 is provided by covering a surface of an elastic member made of an elastic material, such as urethane, with a seat cover made of, for example, resin sheet or leather. The backrest 27 is mounted on the vehicle front side of the back frame 21B and supports the back of the occupant. As the back frame 21B is rotated about the hinge 23, the reclining angle of the backrest 27 is changed. Like the cushion 26, the backrest 27 is also provided by covering a surface of an elastic member made of an elastic material, such as urethane, with a seat cover made of, for example, resin sheet or leather. As shown in FIG. 1, the seat cover located at the rear part of the backrest 27 covers the rear surface of the back frame 21B. Thus, when the seat 20 is viewed from the vehicle rear side, the seat cover located at the vehicle rear part of the backrest 27 is visible. The seat cover located at the vehicle rear part of the backrest 27 will be referred to as a first seat cover 28.

As shown in FIG. 1, a sheet-like second seat cover 29 made of resin or leather is placed over the rear surface of the first seat cover 28 located at the rear part of the backrest 27 with a gap therebetween. The gap between the first seat cover 28 and the second seat cover 29 forms a seat pocket 25. The seat pocket 25 accommodates the vehicle static eliminator 30 therein.

As shown in Details of Part A in FIG. 1, the vehicle static eliminator 30 is composed of a flannel fabric 31, and a PTFE sheet 32 layered on the vehicle rear side of the flannel fabric 31. The flannel fabric 31 is made of a natural fiber with zero electric potential in the triboelectric series and constitutes a first zero potential member with zero triboelectric potential. The PTFE sheet 32 is a sheet member made of polytetrafluoroethylene which is a resin material. The PTFE sheet 32 constitutes a negative charge member that is charged with negative static electricity generated by sliding friction with the flannel fabric 31.

The vehicle static eliminator 30 is sandwiched between the first seat cover 28 and the second seat cover 29 such that the surface of the flannel fabric 31 on the vehicle front side contacts the first seat cover 28 and the surface of the PTFE sheet 32 on the vehicle rear side contacts the second seat cover 29. The first seat cover 28 and the second seat cover 29 then press the PTFE sheet 32 against the flannel fabric 31 in a frictionally slidable manner.

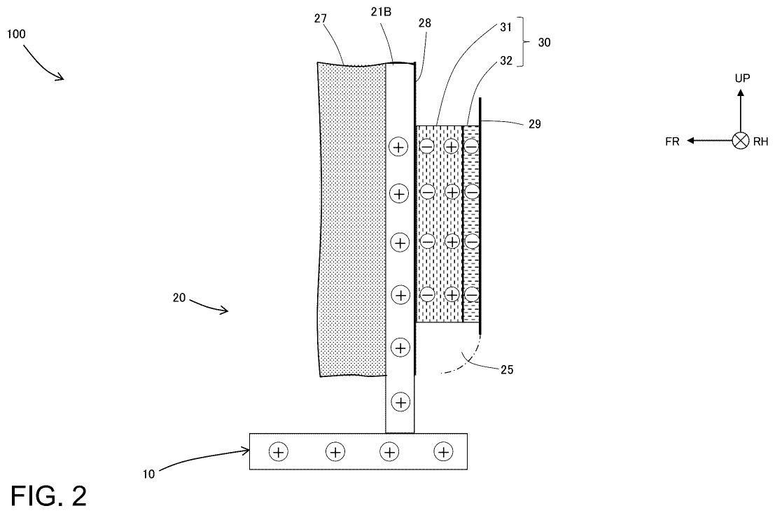

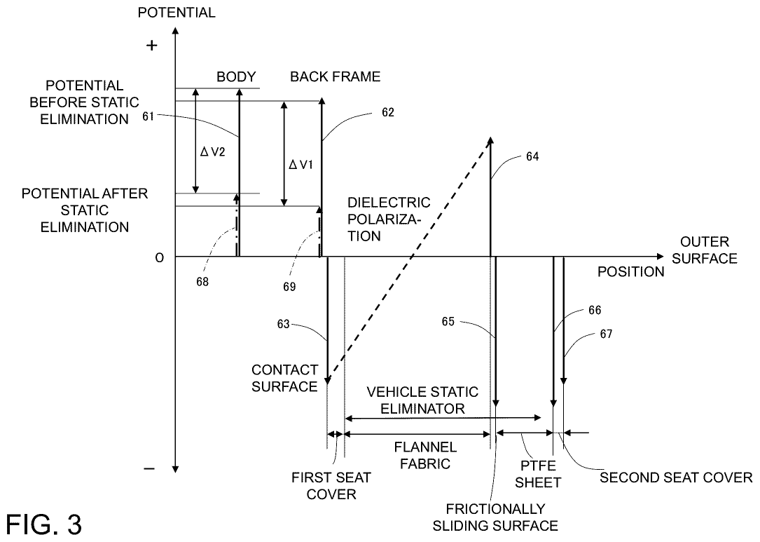

Next, the operation of eliminating static electricity by using the vehicle static eliminator 30 will be described with reference to FIGS. 2 and 3. Although the reason why the vehicle static eliminator 30 can eliminate positive static electricity charged on the body 10 has not been clearly elucidated, the possible reason can be explained as below. In the description below, both the first seat cover 28 and the second seat cover 29 are assumed to be made of resin. In FIG. 3, arrows indicate the polarity and the magnitude of potentials at corresponding sites.

As shown in FIG. 2, when the vehicle 100 runs, the body 10 and the back frame 21B, which is electrically connected to the body 10, are charged with positive static electricity. The body 10 and the back frame 21B thus have a positive potential as indicated by arrows 61 and 62 in FIG. 3. In addition, when the vehicle 100 runs, the PTFE sheet 32 and the flannel fabric 31 frictionally slide with respect to each other due to running vibration and other factors. This causes the PTFE sheet 32 to be charged with negative static electricity as shown in FIG. 2. The PTFE sheet 32 thus has a negative potential as indicated by arrows 65 and 66 in FIG. 3. The second seat cover 29, which is made of resin and in contact with the PTFE sheet 32, also has a negative potential as indicated by an arrow 67 in FIG. 3.

On the other hand, the overall electric potential of the flannel fabric 31 is maintained at zero even when the flannel fabric 31 frictionally slides with the PTFE sheet 32. Therefore, as shown in FIG. 3, the layers of the flannel fabric 31 and the first seat cover 28 generate dielectric polarization. The surface of the flannel fabric 31 which frictionally slides with the PTFE sheet 32 then has a positive potential as indicated by an arrow 64 in FIG. 3. The surface of the flannel fabric 31 on the back frame 21B side and the first seat cover 28 have a negative potential as indicated by an arrow 63 in FIG. 3. Negative static electricity indicated by the arrow 63 and positive static electricity of the back frame 21B indicated by the arrow 62 in FIG. 3 are then neutralized and eliminated, and the positive potential of the back frame 21B is reduced by ΔV1 as indicated by an arrow 69 in FIG. 3. The potential of the body 10, which is electrically connected to the back frame 21B, is reduced by ΔV2 as indicated by an arrow 68 in FIG. 3. As such, the vehicle static eliminator 30 neutralizes and eliminates positive static electricity charged on the back frame 21B by using the negative static electricity generated on the PTFE sheet 32 by friction with the flannel fabric 31.

The vehicle static eliminator 30 reduces the positive potential of the body 10 and prevents the potential of the body 10 from affecting a control system and sensors, thereby enabling the vehicle 100 to exert its original control performance. The vehicle static eliminator 30 also has the simple configuration of the layers of the flannel fabric 31 and the PTFE sheet 32 and can be simply inserted into the seat pocket 25 of the seat 20 without making modifications to the component members of the seat 20. Thus, it is possible to eliminate static electricity from the body 10 even when the vehicle 100 is a vehicle owned by the user.

In the vehicle static eliminator 30, the flannel fabric 31 may be disposed such that its entire surface contacts the first seat cover 28 and the PTFE sheet 32. In this case, the entire surface of the flannel fabric 31 contacts the back frame 21B through the first seat cover 28.

Although, in the above description, the vehicle static eliminator 30 has been described as the layers of the flannel fabric 31 and the PTFE sheet 32, this is not limiting. For example, it is also possible to use, instead of the flannel fabric 31, a material made of a natural fiber with zero electric potential in the triboelectric series, such as, for example, woven cotton fabric or Japanese paper. It is further possible to use a seat made of other resins, such as nonwoven polyester fabric or nonwoven rayon fabric, in place of the PTFE sheet 32 so long as it is a negative charge member to be charged with negative static electricity.

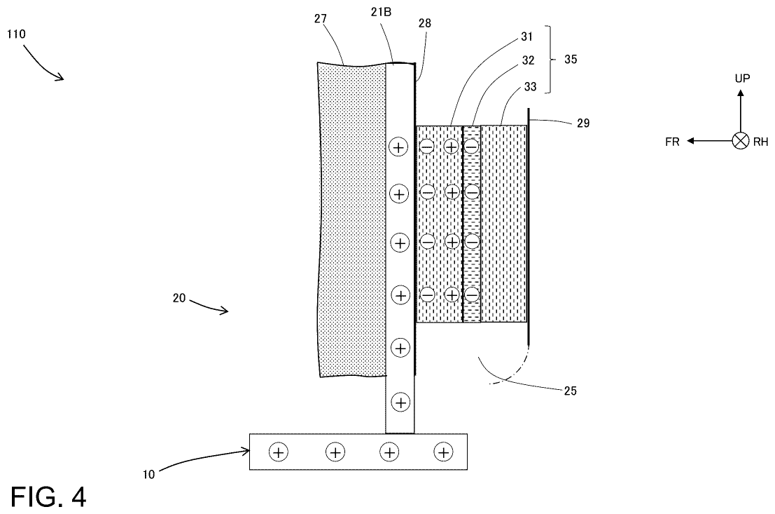

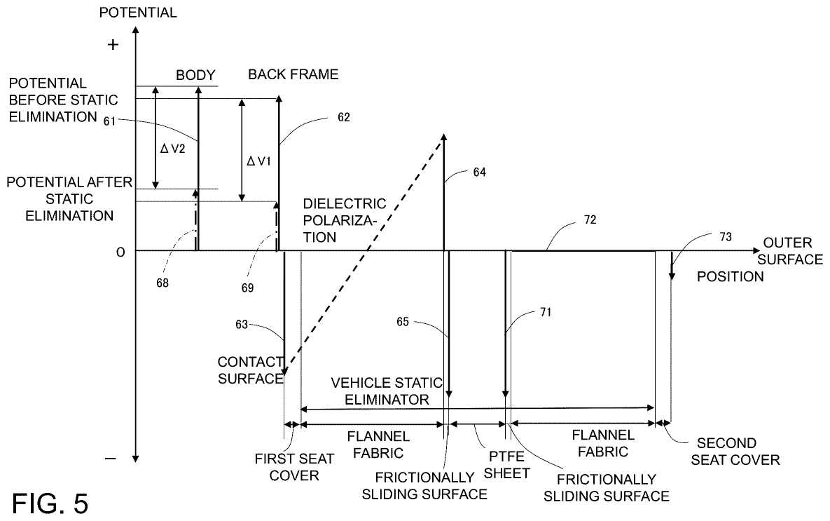

Next, the vehicle 110 on which the vehicle static eliminator 35 according to a second embodiment is mounted will be described with reference to FIGS. 4 and 5. The vehicle 110 is equipped with the vehicle static eliminator 35 in place of the vehicle static eliminator 30 of the vehicle 100 previously described with reference to FIGS. 1 to 3. The other components, such as the body 10 and the seat 20, are identical to those of the vehicle 100. The portions that are identical to those included in the vehicle 100 are assigned the same reference signs, and their repeated descriptions are omitted.

As shown in FIG. 4, the vehicle static eliminator 35 is composed of the flannel fabric 31, the PTFE sheet 32 layered on the vehicle rear side of the flannel fabric 31, and a flannel fabric 33 layered on the vehicle rear side of the PTFE sheet 32. The flannel fabric 33 is layered on the PTFE sheet 32 opposite the flannel fabric 31. Like the flannel fabric 31, it is made of a natural fiber with zero electric potential in the triboelectric series. The flannel fabric 33 constitutes a second zero potential member with zero triboelectric potential.

The flannel fabric 31 is disposed such that its surface on the vehicle front side contacts the back frame 21B indirectly through the first seat cover 28. The flannel fabric 33 is disposed such that its surface on the vehicle front side (one of its surfaces) is layered on the PTFE sheet 32 opposite the back frame 21B (that is, layered on the rear side of the PTFE sheet 32), and its surface on the vehicle rear side (the other one of the surfaces) contacts the second seat cover 29. Thus, the vehicle static eliminator 35 is sandwiched between the first seat cover 28 and the second seat cover 29. The PTFE sheet 32 is then pressed against the flannel fabric 31 in a frictionally slidable manner by using the first seat cover 28 and the second seat cover 29.

Next, the operation of eliminating static electricity by the vehicle static eliminator 35 will be described. Although the reason why the vehicle static eliminator 35 can eliminate positive static electricity charged on the body 10 has not been clearly elucidated, the possible reason can be explained as below. In the description below, both the first seat cover 28 and the second seat cover 29 are assumed to be made of resin. In FIG. 5, arrows indicate the polarity and the magnitude of potentials at corresponding sites.

As described above with reference to FIG. 3, frictional sliding between the flannel fabric 31 and the PTFE sheet 32 and dielectric polarization generates, in the flannel fabric 31 and the PTFE sheet 32, the negative potential indicated by the arrows 63 and 65 and the positive potential indicated by the arrow 64. The negative static electricity indicated by the arrow 63 and the positive static electricity of the back frame 21B indicated by the arrow 62 in FIG. 3 are then neutralized, and the positive potentials of the body 10 and the back frame 21B are reduced as indicated by the arrows 68 and 69 in FIG. 5.

When the vehicle 110 runs, the PTFE sheet 32 and the flannel fabric 33 frictionally slide with respect to each other due to running vibration and other factors. This causes the PTFE sheet 32 to be charged with negative static electricity as shown in FIG. 4 and as indicated by an arrow 71 in FIG. 5. Like the flannel fabric 31, the overall electric potential of the flannel fabric 33 is also maintained at zero even when the flannel fabric 33 frictionally slides with the PTFE sheet 32. However, the flannel fabric 33 has no component member charged with positive static electricity on its vehicle rear side, like the back frame 21B. Therefore, as shown in FIG. 5, the flannel fabric 33 generates no dielectric polarization and has a potential of zero as a whole as indicated by a solid line 72 in FIG. 5. This makes it possible to prevent discharge of negative static electricity generated in the PTFE sheet 32 to the outside from the side of the second seat cover 29. The second seat cover 29 is made of resin and has a negative potential as indicated by an arrow 73 in FIG. 5 generated by, for example, friction with the flannel fabric 33.

As described above, in the vehicle static eliminator 35, the flannel fabric 33 is layered on the PTFE sheet 32 opposite the back frame 21B (that is, layered on the rear side of the PTFE sheet 32), and thus there can be prevented discharge of negative static electricity generated on the PTFE sheet 32 to the outside from the second seat cover 29 on the rear side. This allows the vehicle static eliminator 35 to effectively neutralize and eliminate negative static electricity generated in the PTFE sheet 32 by using positive static electricity charged on the back frame 21B. The vehicle static eliminator 35 can also effectively eliminate positive static electricity from the body 10 and reduce the potential of the body 10. The vehicle static eliminator 35 can further effectively prevent the potential of the body 10 from affecting a control system and sensors, thereby enabling the vehicle 110 to exert its original control performance.

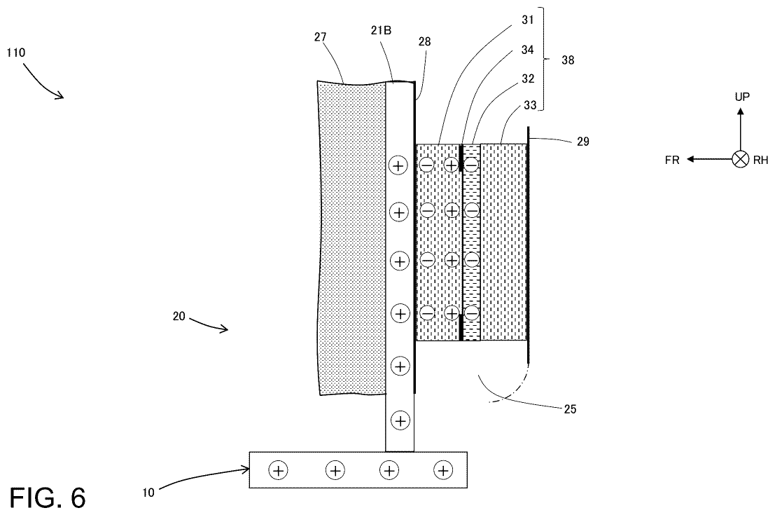

Next, a vehicle static eliminator 38 which is a modification of the vehicle static eliminator 35 described above with reference to FIGS. 4 and 5 and is mounted on the vehicle 110 will be described with reference to FIG. 6. The vehicle static eliminator 38 is formed by attaching masking tape 34 to a peripheral portion of the PTFE sheet 32 and layering the peripheral portion of the PTFE sheet 32 on the flannel fabric 31 through the masking tape 34. This makes it possible to reduce the area of sliding friction that generates negative static electricity and adjust the potential obtained after neutralization and elimination to be closer to zero. The basic action and effect of the vehicle static eliminator 38 are similar to those of the vehicle static eliminator 35 described above with reference to FIGS. 4 and 5.

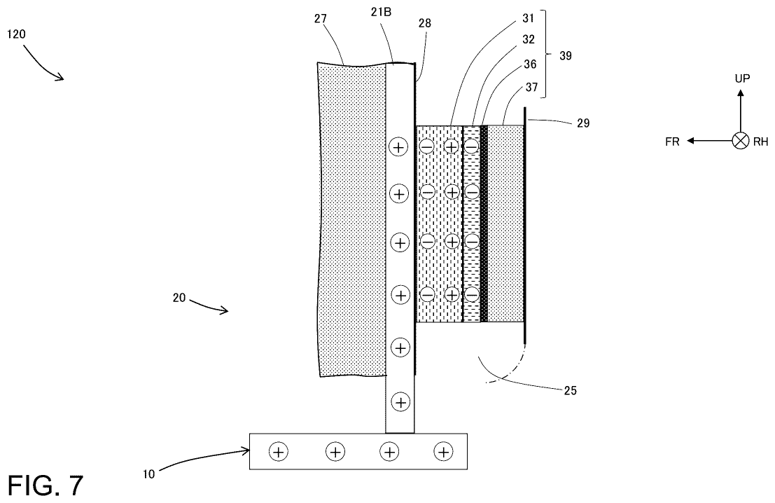

Next, the vehicle 120 on which the vehicle static eliminator 39 according to a third embodiment is mounted will be described with reference to FIG. 7. The vehicle 120 is equipped with the vehicle static eliminator 39 in place of the vehicle static eliminator 35 of the vehicle 110 described above with reference to FIGS. 4 to 5. The other components, such as the body 10 and the seat 20, are identical to those of the vehicles 100 and 110. The portions that are identical to those included in the vehicles 100 and 110 are assigned the same reference signs, and their repeated descriptions are omitted.

As shown in FIG. 7, the vehicle static eliminator 39 is formed by layering the flannel fabric 31 and the PTFE sheet 32 and attaching a PP sheet 37 that is an antistatic resin member to the rear surface of the PTFE sheet 32 with a silicone adhesive material 36. The PP sheet 37 is layered on the PTFE sheet 32 opposite the back frame 21B.

The PP sheet 37 is a polypropylene resin sheet subjected to antistatic processing, and the silicon adhesive material 36 has static-eliminating properties. As the PP sheet 37 is layered on the PTFE sheet 32 opposite the back frame 21B, there can be prevented discharge of negative static electricity generated on the PTFE sheet 32 to the outside from the second seat cover 29, which is located on the side opposite to the back frame 21B. This allows the vehicle static eliminator 39 to effectively neutralize and eliminate negative static electricity generated in the PTFE sheet 32 by using positive static electricity charged on the back frame 21B. The vehicle static eliminator 39 can thus effectively eliminate positive static electricity from the body 10 and reduce the potential of the body 10.

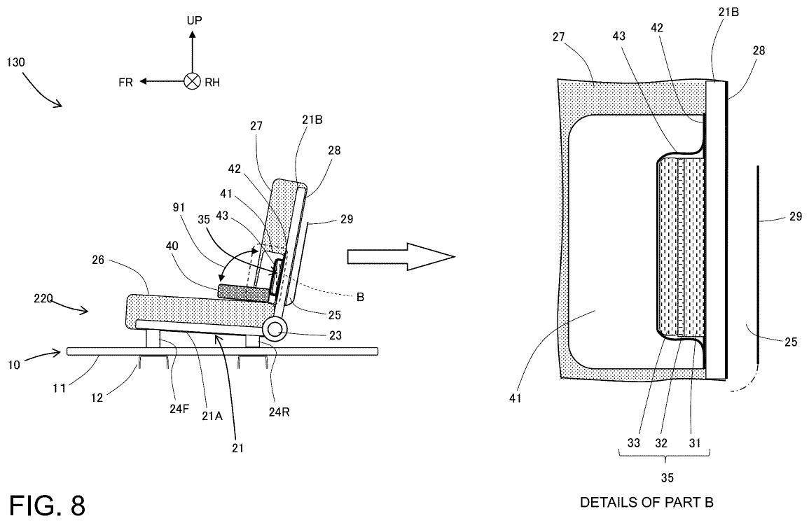

Next, the vehicle 130 according to another embodiment will be described with reference to FIG. 8. A seat 220 of the vehicle 130 has retractable armrests 40. The armrest 40 rotates as indicated by an arrow 91 in FIG. 8 and is accommodated in a recess 41 in the backrest 27. The remainder of the configuration of the seat 220 is similar to that of the seat 20 described above with reference to FIG. 1, and thus its repeated description is omitted.

As shown in Details of Part B in FIG. 8, a resin bottom cover 42 is attached to a bottom surface or a vehicle rear side surface of the recess 41. The bottom cover 42 covers a vehicle front side outer surface of the back frame 21B. The vehicle static eliminator 35 described above with reference to FIGS. 4 and 5 is disposed on a vehicle front side surface of the bottom cover 42. The flannel fabric 31 of the vehicle static eliminator 35 is in contact with the back frame 21B through the bottom cover 42. The flannel fabric 33 located at the vehicle front part of the vehicle static eliminator 35 is covered by a resin front cover 43. The PTFE sheet 32 is sandwiched between the flannel fabric 31 and the flannel fabric 33. A peripheral portion of the front cover 43 is fixed to the surface of the bottom cover 42 to thereby press the PTFE sheet 32 against the flannel fabric 31 in a frictionally slidable manner.

The vehicle static eliminator 35 mounted on the vehicle 130 neutralizes and eliminates negative static electricity charged on the PTFE sheet 32 and positive static electricity charged on the back frame 21B by frictional sliding between the flannel fabric 31 and the PTFE sheet 32 and dielectric polarization. As a result, the positive potentials of the back frame 21B and the body 10 are reduced.

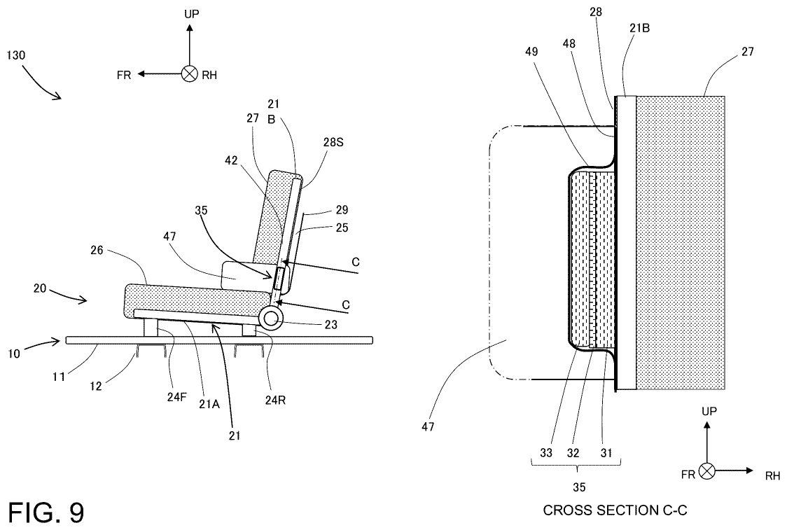

Next, the configuration of the vehicle static eliminator 35 installed in a box 47 of the vehicle 130 will be described with reference to FIG. 9. As shown in FIG. 9, in the vehicle 130, the box 47 is disposed adjacent to the seat 20. As shown in a cross-section C-C in FIG. 9, the right side of the box 47 is adjacent to the left side surface of the back frame 21B.

A resin first side cover 48 is attached to the right side inside the box 47. The first side cover 48 covers a vehicle left side surface of the back frame 21B. The vehicle static eliminator 35 described above with reference to FIGS. 4 and 5 is disposed on a vehicle left side surface of the first side cover 48. The flannel fabric 31 of the vehicle static eliminator 35 is in contact with the side surface of the back frame 21B through the first side cover 48. The flannel fabric 33 located at the vehicle left part of the vehicle static eliminator 35 is covered by a resin second side cover 49. The PTFE sheet 32 is sandwiched between the flannel fabric 31 and the flannel fabric 33. A peripheral portion of the second side cover 49 is fixed to the surface of the first side cover 48 to press the PTFE sheet 32 against the flannel fabric 31 in a frictionally slidable manner.

The action and effect of the vehicle static eliminator 35 shown in FIG. 9 are similar to those of the vehicle static eliminator 35 described above with reference to FIG. 8.

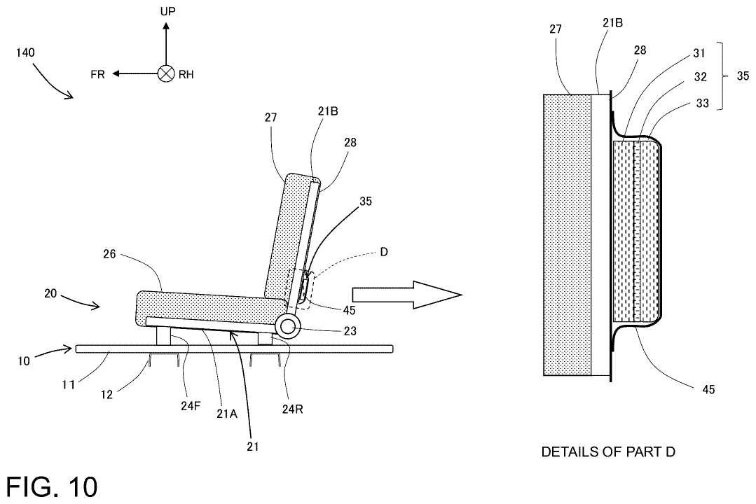

Next, the vehicle 140 according to another embodiment will be described with reference to FIG. 10. The vehicle 140 is achieved by attaching the vehicle static eliminator 35 described above with reference to FIGS. 4 and 5 to the lower side of the back of the backrest 27 of the vehicle 100 described above with reference to FIG. 1. In FIG. 10, the second seat cover 29 and the seat pocket 25 are omitted.

As shown in Details of Part D in FIG. 10, the vehicle static eliminator 35 is disposed on a vehicle rear side surface of the first seat cover 28. The flannel fabric 31 of the vehicle static eliminator 35 is in contact with the back frame 21B through the first seat cover 28. The flannel fabric 33 located at the vehicle rear part of the vehicle static eliminator 35 is covered by a resin rear cover 45. The PTFE sheet 32 is sandwiched between the flannel fabric 31 and the flannel fabric 33. A peripheral portion of the rear cover 45 is fixed to the surface of the first seat cover 28 to press the PTFE sheet 32 against the flannel fabric 31 in a frictionally slidable manner.

Like the vehicle static eliminator 35 mounted on the vehicle 130, the vehicle static eliminator 35 mounted on the vehicle 140 neutralizes and eliminates negative static electricity charged on the PTFE sheet 32 and positive static electricity charged on the back frame 21B by frictional sliding between the flannel fabric 31 and the PTFE sheet 32 and dielectric polarization.

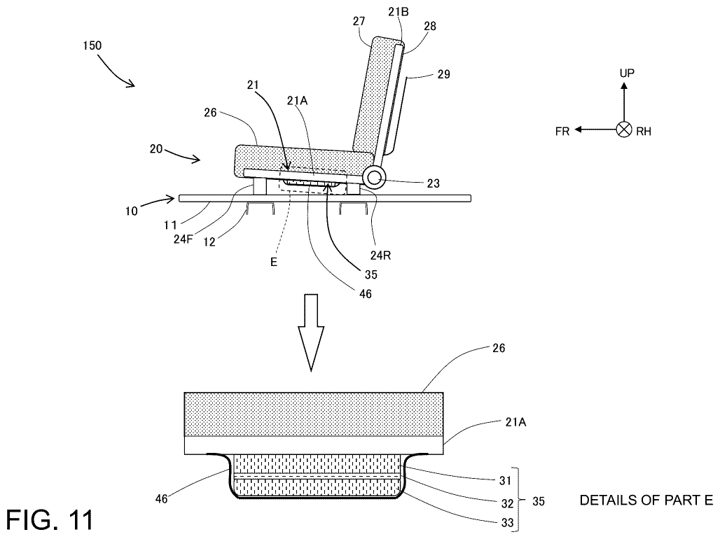

Next, the vehicle 150 according to another embodiment will be described with reference to FIG. 11. The portions that are similar to those of the vehicle 100 described above with reference to FIG. 1 are assigned the same reference signs, and their repeated descriptions are omitted.

As shown in FIG. 11, the vehicle 150 is achieved by attaching the vehicle static eliminator 35 to the lower side of the main frame 21A of the vehicle 100 described above with reference to FIG. 1. As shown in Details of Part E in FIG. 11, the flannel fabric 31 at the upper part of the vehicle static eliminator 35 is in direct contact with the main frame 21A. The flannel fabric 33 is located at the lower part of the vehicle static eliminator 35 such that it is layered on the PTFE sheet 32 opposite the main frame 21A (that is, layered on the lower side). The PTFE sheet 32 is sandwiched between the flannel fabric 31 and the flannel fabric 33. The outside of the flannel fabric 33 is covered by an outer cover 46. A peripheral portion of the outer cover 46 is fixed to the surface of the main frame 21A to crimp the vehicle static eliminator 35 to the main frame 21A, to thereby press the PTFE sheet 32 against the flannel fabric 31 in a frictionally slidable manner.

Like the vehicle static eliminator 35 mounted on the vehicles 130 and 140, the vehicle static eliminator 35 mounted on the vehicle 150 neutralizes and eliminates negative static electricity charged on the PTFE sheet 32 and positive static electricity charged on the main frame 21A and the body 10 by frictional sliding between the flannel fabric 31 and the PTFE sheet 32 and dielectric polarization.

In the vehicle static eliminator 35, the flannel fabric 31 may be disposed such that its entire surface directly contacts the main frame 21A.

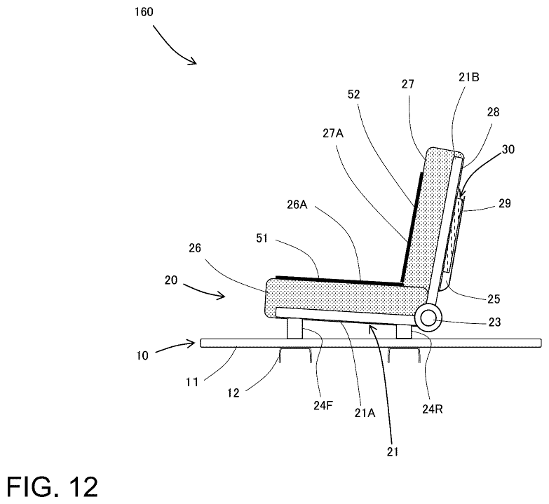

Next, the vehicle 160 according to another embodiment will be described with reference to FIG. 12. The vehicle 160 is achieved by applying antistatic agents 51 and 52 to the surfaces of the cushion 26 and the backrest 27, respectively, of the seat 20 of the vehicle 100 described above with reference to FIG. 1.

As described above with reference to FIG. 1, the cushion 26 and the backrest 27 of the seat 20 are provided by covering the surfaces of the elastic members made of elastic material, such as urethane, with the seat covers made of, for example, resin sheet or leather. The antistatic agents 51 and 52 are respectively applied to a seating surface of an upper seat cover 26A of the cushion 26 on which the occupant sits and to a backrest surface of a front seat cover 27A of the backrest 27 that supports the back of the occupant. Here, the seat covers 26A and 27A respectively constitute the skin of the cushion 26 and the backrest 27.

By applying the antistatic agents 51 and 52 to the seating surface and the backrest surface of the seat covers 26A and 27A that are to be in contact with the occupant, the seat covers 26A and 27A are prevented from being charged with electricity, and unstable electrostatic induction between the occupant and the back frame 21B or between the occupant and the main frame 21A can be reduced. This makes it possible to stabilize the dielectric polarization of the flannel fabric 31 between the back frame 21B and the PTFE sheet 32 shown in FIGS. 3 and 5 and stably reduce the potential of the back frame 21B to almost zero.

Here, various types of the antistatic agents 51 and 52 can be used. By using suitable types of antistatic agents according to the material of the seat covers 26A and 27A, it is possible to effectively prevent the seat covers 26A and 27A from being charged with electricity. For example, if the seat covers 26A and 27A are made of a synthetic resin material which is on the negative side in the triboelectric series, such as non-woven synthetic resin fiber fabric or synthetic leather which uses synthetic resin having micro unevenness, it is effective to apply the antistatic agents 51 and 52 containing a cationic surfactant. If the seat covers 26A and 27A are made of leather material which is on the positive side in the triboelectric series, such as genuine leather having micro unevenness, it is effective to apply the antistatic agents 51 and 52 containing a fluoropolymer agent.

As explained above, the vehicle static eliminators 30, 35, 38, and 39 of the embodiments can effectively eliminate positive static electricity charged on the vehicles 100, 110, 120, 130, 140, 150, and 160. The vehicle static eliminators 30, 35, 38, and 39 thus enable the vehicles 100, 110, 120, 130, 140, 150, and 160 to exert their original control performance. Each of the vehicle static eliminators 30, 35, 38, and 39 has a simple configuration of the layers of the flannel fabric 31 and the PTFE sheet 32 and does not require any modifications to the surface skin of the component members of the seat 20. Therefore, it is possible to easily install the vehicle static eliminators 30, 35, 38, and 39 in the vehicles 100, 110, 120, 130, 140, 150, and 160 and easily eliminate static electricity from the body 10 even when the vehicles 100, 110, 120, 130, 140, 150, and 160 are the vehicles owned by the users.

1. A vehicle static eliminator comprising:
a first zero potential member that directly or indirectly contacts a metal interior member mounted on a body of a vehicle and has zero triboelectric potential; and
a negative charge member that is layered on the first zero potential member so as to frictionally slide with the first zero potential member and is charged with negative static electricity generated by sliding friction with the first zero potential member, wherein
positive static electricity charged on the body is neutralized and eliminated.

2. The vehicle static eliminator according to claim 1, wherein
the first zero potential member is made of a natural fiber with zero electric potential in the triboelectric series, and
the negative charge member is made of a resin material.

3. The vehicle static eliminator according to claim 2, comprising a second zero potential member that is layered on the negative charge member opposite the first zero potential member, wherein
the second zero potential member is made of a natural fiber with zero electric potential in the triboelectric series.

4. The vehicle static eliminator according to claim 2, comprising an antistatic resin member that is layered on the negative charge member opposite the first zero potential member, wherein
the antistatic resin member is attached to the negative charge member with an adhesive material.

5. A vehicle on which the vehicle static eliminator according to claim 2 is mounted, the vehicle comprising a seat including a seat frame that is the interior member, a first seat cover that covers the outside of the seat frame, and a second seat cover that covers the outside of the first seat cover, wherein
the vehicle static eliminator is sandwiched between the first seat cover and the second seat cover,
the first zero potential member is disposed so as to contact the seat frame indirectly through the first seat cover, and
the negative charge member is sandwiched between the first zero potential member and the second seat cover and is pressed against the first zero potential member in a frictionally slidable manner.

6. A vehicle on which the vehicle static eliminator according to claim 3 is mounted, the vehicle comprising a seat including
a seat frame that is the interior member,
a first seat cover that covers the outside of the seat frame, and
a second seat cover that covers the outside of the first seat cover, wherein
the vehicle static eliminator is sandwiched between the first seat cover and the second seat cover,
the first zero potential member is disposed so as to contact the seat frame indirectly through the first seat cover,
the second zero potential member is disposed such that one side of the second zero potential member is layered on the negative charge member opposite the seat frame, and the other side of the second zero potential member contacts the second seat cover, and
the negative charge member is sandwiched between the first zero potential member and the second zero potential member and is pressed against the first zero potential member in a frictionally slidable manner.

7. A vehicle on which the vehicle static eliminator according to claim 4 is mounted, the vehicle comprising a seat including
a seat frame that is the interior member,
a first seat cover that covers the outside of the seat frame, and
a second seat cover that covers the outside of the first seat cover, wherein
the vehicle static eliminator is sandwiched between the first seat cover and the second seat cover,
the first zero potential member is disposed so as to contact the seat frame indirectly through the first seat cover,
the antistatic resin member is disposed such that one side of the antistatic resin member is layered on the negative charge member opposite the seat frame, and the other side of the antistatic resin member contacts the second seat cover, and
the negative charge member is pressed against the first zero potential member in a frictionally slidable manner.

8. A vehicle on which the vehicle static eliminator according to claim 3 is mounted, the vehicle comprising a seat having a seat frame that is the interior member, wherein
the vehicle static eliminator is mounted such that the first zero potential member directly contacts the seat frame, and the second zero potential member is layered on the negative charge member opposite the seat frame and crimped to the seat frame by means of an outer cover covering an outer surface of the second zero potential member, and
the negative charge member is sandwiched between the first zero potential member and the second zero potential member and is pressed against the first zero potential member in a frictionally slidable manner.

9. The vehicle according to claim 5, wherein
the seat comprises a back frame that supports the back of an occupant,
the first seat cover covers a rear surface of the back frame, and
the second seat cover is placed over a rear surface of the first seat cover to thereby form a seat pocket on a rear surface of the seat.

10. The vehicle according to claim 5, wherein
the seat comprises a back frame that supports the back of an occupant,
the first seat cover covers a rear surface of the back frame, and
the second seat cover is a rear cover that has a peripheral portion fixed to a surface of the first seat cover and presses the negative charge member and the first zero potential member against each other in a frictionally slidable manner.

11. The vehicle according to claim 5, wherein
the seat comprises
a recess that accommodates a retractable armrest, and
a back frame that supports the back of an occupant,
the first seat cover is a bottom cover that covers a front surface of the back frame at a bottom of the recess, and
the second seat cover is a front cover that has a peripheral portion fixed to a surface of the bottom cover and presses the negative charge member and the first zero potential member against each other in a frictionally slidable manner.

12. The vehicle according to claim 5, comprising a box provided adjacent to the seat, wherein
the seat comprises a back frame that supports the back of an occupant,
the first seat cover is a first side cover that covers a side surface of the back frame on one side inside the box, and
the second seat cover is a second side cover that has a peripheral portion fixed to a surface of the first side cover and presses the negative charge member and the first zero potential member against each other in a frictionally slidable manner.

13. The vehicle according to claim 5, wherein the first zero potential member is disposed such that its entire surface directly or indirectly contacts the seat frame.

14. The vehicle according to claim 5, wherein
the seat frame includes a main frame that supports the buttocks of the occupant and a back frame that supports the back of the occupant,
the seat comprises a cushion attached to the main frame and a backrest attached to the back frame, and
an antistatic agent is applied to a seating surface of the cushion and a backrest surface of the backrest.

15. The vehicle according to claim 14, wherein
skin of the cushion and the backrest is made of a synthetic resin material, and
the antistatic agent contains a cationic surfactant.

16. The vehicle according to claim 14, wherein
skin of the cushion and the backrest is made of a leather material, and
the antistatic agent contains a fluoropolymer agent.
